(19) United States
(12) Patent Application Publication
(10) Pub. No.: US 2007/0100739 A1
(43) Pub. Date: May 3, 2007

(54) Method and system for implementing a target group for integrated auction services on a seller's e-commerce site

(75) Inventors: Yan Cui, Sunnyvale, CA (US); Rupa Jaganathan, Richmond (CA); Yue Fang, Sunnyvale, CA (US); Pavan Bayyapu, Sunnyvale, CA (US); Anisha Dadhia, San Jose, CA (US)

Correspondence Address: KENYON & KENYON LLP, 1500 K STREET N.W., WASHINGTON, DC, 20005, US

(73) Assignee: SAP AG

(21) Appl. No.: 11/590,968

(22) Filed: Oct. 31, 2006

Related U.S. Application Data
(60) Provisional application No. 60/731,250, filed on Oct. 31, 2005.

(51) Int. Cl. G06Q 40/00

(52) U.S. Cl. 705/37

(57) ABSTRACT

A seller may designate a target group of customers allowed to access an auction on a seller's e-commerce site in an internal auction system creating a bidder restriction on the auction. Customers not in this target group are not allowed to see auction details and may not participate in the auction. The target group may be designated by the seller during auction creation or editing. The target group may be defined using customer relationship management (CRM) components as part of the seller's business information management system(s). Selecting a target group for the auction creates a bidder restriction preventing other potential bidders from viewing auction information and participating in the auction. Alternatively, a first bidder restriction may exist to control which customers may view the auction information and a second bidder restriction may be used to limit which of these first bidder restriction customers may participate in the auction.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for providing integrated auction services through a seller's e-commerce site. In particular, the present invention relates to restricting access to integrated auction services through target groups in an internal auction system.

### BACKGROUND

Businesses traditionally look for effective ways in which to make their products available to potential buyers. In addition to sales through physical “brick and mortar” stores, innovative ways to sell products are often used especially to dispose of old or excess inventory. The advent of the Internet along with the accompanying revolution in computer and network technology has created new sales paradigms and allowed businesses to establish their own electronic commerce (“e-commerce”) presence through the use of, for example, Internet Web sites. E-commerce sales have steadily grown and now account for a significant portion of business-to-consumer as well as business-to-business sales. Auctions make up a significant portion of e-commerce sales and have grown into an increasingly more important sales paradigm.

The revolution in network and computer capability along with the mass availability and development of the Internet facilitates alternative methods of sales such as auctions. Network-based electronic auctions, such as for example those conducted over the Internet, may allow a seller considerable control over an auction and may increase auction participation. For example, a seller may want to limit participation in the auction where the potential pool of potential customers is limited or where allowing an open auction may, in some manner, hinder the auction process. In another example where an auction may be open to all potential bidders it is often beneficial to maximize the number of people participating in the auction in order to extract the greatest price for the product or lot being auctioned. The Internet and network-based computing provide the ability to aggregate large numbers of bidders for an auction in an easier and generally less costly manner than through traditional auctions. Though network-based auctions (e.g., Internet based auctions) provide significant advantages, the reliance on third party auction providers has limited a seller's control in a number of ways including through rules on the conformance of auction procedures and the loss of control over restricting auction participation and bidding.

Third party auction providers provide a large scale e-commerce community portal that brings together large numbers of buyers and sellers who gather to trade in goods and services. Everyday, millions of items across thousands of categories are available on third party auction providers for sale by auction and for a fixed price, enabling trade on a local, national, and international basis with customized Internet Web sites in markets around the world. These third party auction providers may provide auction services for the seller as well as access to a ready pool of potential buyers but in exchange they may require a seller to conform their auctioning processes and procedures. In addition, a third party auction provider typically takes a fee that may be fixed or proportional to the value of the auctioned goods and/or services. In both cases, the seller loses some degree of control over the auction process in exchange for using the third party auction service.

In addition to the limitations on auction procedures and processes imposed by a third party auction provider, a business may not be able to make maximum use of its business information in providing and generating auctions through a third party auction service. Businesses have typically kept their information, including information regarding their assets and inventory they wish to sell or auction off, in database systems that are part of their corporate information systems. Conventional systems provide limited linking between these business information management systems and online Web auction services, and, therefore, manual involvement with the Web auction service is required for each auction or sales posting conducted. These problems may be overcome and the limitations of third party auction services avoided by providing auction services through a seller's own e-commerce site. In this manner, full advantage may be taken by linking a seller's business information management systems with its e-commerce site allowing greater automation of the auction submission, tracking, and post-auction processing. An integrated internal auction system solves these problems in a novel manner providing considerable advantages to a seller. In this manner, a seller may be able to control customer access to an auction on a seller's internal auction system.

### BRIEF DESCRIPTION OF THE DRAWINGS

FIG. 1a is a diagram illustrating the integrated internal auction system according to one embodiment of the present invention.

FIG. 1b is a diagram illustrating a general integrated auction process according to one embodiment of the present invention.

FIG. 2 is a flowchart illustrating the auction creation process using an internal auction application where the designation of a target group may be made according to one embodiment of the present invention.

FIG. 3 is a flowchart illustrating the process for making available an auction with a defined target group on a seller's e-commerce site according to one embodiment of the present invention.

FIG. 4a is an example data architecture for implementing a bidder restriction for an auction using a target group according to one embodiment of the present invention.

FIG. 4b is an example data architecture for implementing a bidder restriction for an auction using a customer identifier instead of a target group according to one embodiment of the present invention.

FIG. 5 is a screen shot from an internal auction application illustrating an auction listing screen from which a seller may choose to create a new auction with a bidder restriction according to one embodiment of the present invention.

FIG. 6 is a screen shot from an internal auction application illustrating an auction creation screen from which a bidder restriction may be specified according to one embodiment of the present invention.

FIG. 7 is a screen shot from an internal auction application illustrating the change rules screen presented to a seller during the auction creation process according to one embodiment of the present invention.

FIG. 8 is a screen shot from an internal auction application illustrating the auction creation screen with general auction information entered according to one embodiment of the present invention.

FIG. 9 is a screen shot from an internal auction application illustrating the initiation of a bidder restriction on the auction by designating target groups according to one embodiment of the present invention.

FIG. 10 is a screen shot from an internal auction application illustrating the target group designation screen of the auction creation process where a bidder restriction may be created according to one embodiment of the present invention.

FIG. 11 is a screen shot from an internal auction application illustrating a business partner search results screen for selecting bidder restrictions on an auction during the auction creation process according to one embodiment of the present invention.

FIG. 12 is a screen shot from an internal auction application illustrating an invitation list containing the selected customers in the bidder restriction or target group for the auction according to one embodiment of the present invention.

FIG. 13 is a screen shot from an internal auction application illustrating a verification screen for the saved auction information from the auction creation process according to one embodiment of the present invention.

FIG. 14 is a screen shot from a seller's e-commerce site illustrating auction information that a customer may view if they are part of a target group for a bidder restriction on the auction according to one embodiment of the present invention.

FIG. 15 is a block diagram illustrating the platform on which the method and system for controlling a customer's access to an auction for a product in an internal auction system using an internal auction application may operate according to one embodiment of the present invention.

### DETAILED DESCRIPTION

According to one embodiment of the present invention, a method and system for providing an integrated auction capability through a seller's e-commerce site is provided through an internal auction system. The internal auction system may include a seller-side application to allow a seller to generate an auction using an available seller business information management system, publish the auction on a seller's e-commerce site, process an auction winner, and monitor ongoing auctions in a manner leveraging a seller's existing business information management systems and e-commerce sites. The internal auction system may also include a buyer-side application to provide a buyer functionality on a seller's e-commerce site to view and participate in published auctions, to monitor auctions and bidding, and to perform any necessary checkout procedures on winning an auction. The internal auction system serves as the conduit between seller's business information management system(s) and e-commerce site(s) while providing seller and/or buyer functionality to implement an integrated auction capability under the seller's internal control (i.e., without using an external third party auction provider or facilitator).

In one embodiment of the present invention, the seller may designate a target group of customers allowed to access the auction thereby creating a bidder restriction on the auction where customers not in this target group are not allowed to see the auction and its details as well as not being allowed to participate in the auction. The target group may be designated by the seller when the auction is first created or it may be specified during the modification of the auction. The example embodiments described below relate to the auction creation process but they may equally apply with appropriate modification to the editing and updating of a saved auction in the internal auction system according to one embodiment of the present invention. In addition the term “target group” is used herein to refer to a designated target group containing already specified customers as well as to individually identified customers or business partners that may be selected by the seller. A target group may be defined by using business partner (i.e., customer) selection options provided by or through an internal auction application. In addition, a target group may be defined and/or edited using customer relationship management (CRM) components and/or a CRM-based system that is part of the seller's business information management system(s). Selecting a target group for the auction creates a bidder restriction preventing other potential bidders from viewing any auction information and/or participating in the auction. In an alternative embodiment of the present invention, a separate first bidder restriction may exist to control which customers may view the auction information and a second bidder restriction containing a subset of the first bidder restriction set of customers may be used to limit which of the customers who are allowed to view the auction may participate in the auction.

The example embodiment discussed herein is for a private auction where access is limited to customers defined in the target group. In an alternative embodiment of the present invention for a public auction, the target group may be used to identify which customers are notified about the auction but the target group is not used to restrict participation in the auction. The changes necessary to implement this embodiment over the example embodiment discussed herein should be evident to those skilled in the art.

According to one embodiment of the present invention, the internal auction application links a seller's e-commerce site with a seller's existing business information management system(s) in order to provide auction services to buyers through the seller's e-commerce site. A seller's e-commerce site according to this embodiment may be any electronic business presence that a seller provides to potential buyers. For example, a seller's Web site on the Internet that offers information on or purchase of seller's products can be considered a seller's e-commerce site. A seller's business information management system according to this embodiment may be any seller information system containing product and/or sales and marketing information that may be used in the provision of products to a buyer. For example, a seller's inventory system that tracks the availability of seller's products may be considered one form of many potential seller's business information management systems. A seller's business information management system implies business applications using a programming and/or program interface working with a database to accomplish one or more tasks. However, according to this embodiment a seller's business information management system may be considered either the database and the interface to access the database by itself as well as this database and associated interface in conjunction with associated applications. The internal auction application according to this embodiment provides the functionality to implement the auctioning of seller products (i.e., products sold by the seller) on the seller's e-commerce site in conjunction with using at least one of the seller's business information management systems.

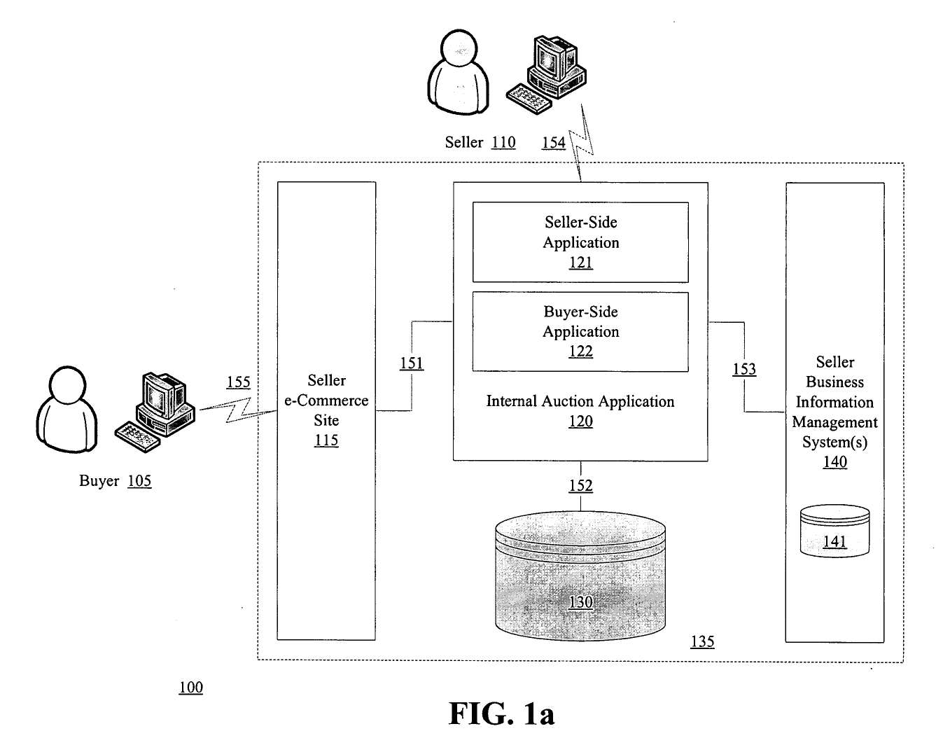

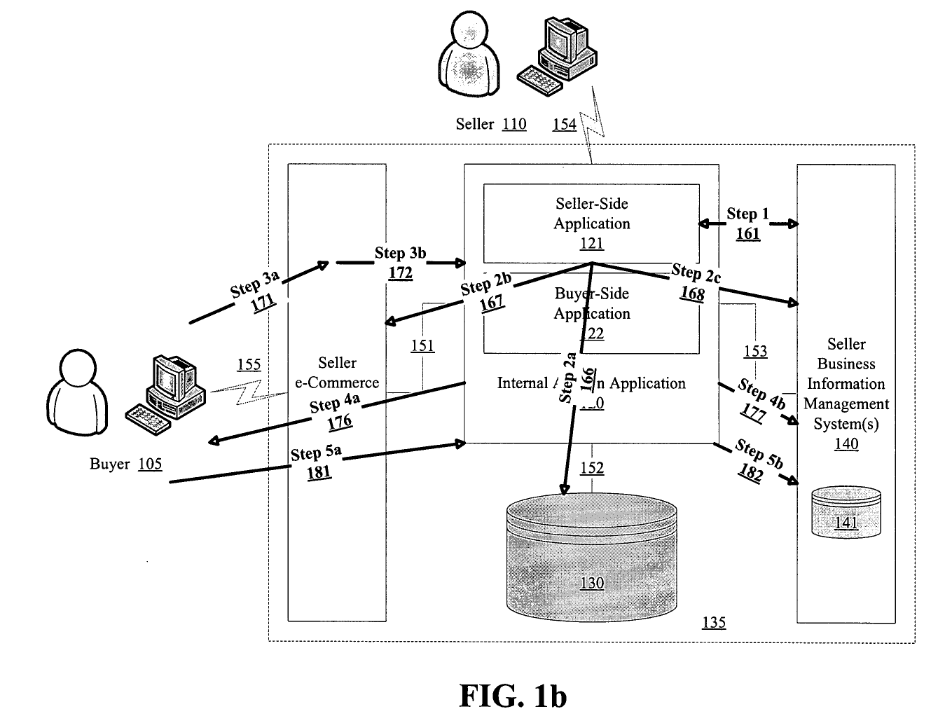

FIG. 1a is a diagram illustrating the integrated internal auction system according to one embodiment of the present invention. A seller 110 may create an auction using an internal auction application 120 residing on the seller's information technology hardware environment 135. For example, the internal auction application 120 may consist of one or more software applications, programs, modules, procedures, or other computer code to include firmware and may additionally include data that resides on one or more servers, computers, or other hardware platforms that make up the seller's information technology hardware environment 135. The internal auction application 120 may be conceptualized as containing a seller-side application 121 handling the seller interaction 154 with the integrated internal auction system 100 through the internal auction application 120. The seller-side application 121 may provide the functionality allowing the seller 110 to create, monitor, and manage one or more auctions. The internal auction application 120 may also be conceptualized as containing a buyer-side application 122 handling the buyer interaction 155 with the integrated internal auction system 100 allowing buyer interaction 155 with the internal auction application 120 and the seller's business information management system(s) 140 through a seller's e-commerce site 115. The buyer-side application 122 may provide the functionality allowing the buyer 105 to view auctions, participate in active auctions, monitor auctions, and perform the checkout process on won auctions. Though conceptually the functionality provided by the seller-side application 121 and the buyer-side application 122 of the internal auction application 120 are different, both may share data sets, procedures, libraries, and other elements of software code or data. In one embodiment of the present invention, all the elements of the internal auction application 120 may either be contained in both the conceptual subsets-seller-side application 121 and buyer-side application 122-or in an alternative embodiment the internal auction application 120 may contain additional elements of software code and/or data in addition to these conceptual subsets 121, 122. The internal auction application 120 uses data that may be contained in a seller's business information management system(s) 140 and/or may be stored in a local database 130 for the internal auction application 120. This local database 130 may be considered part of the internal auction application 120 in this embodiment of the present invention even if the database is stored separately in a memory or storage system.

An internal auction application 120 may communicate 152 with the local database 130; communicate 153 with the seller's business information management system(s) 140; and communicate 151 with the seller's e-commerce site 115 using a communication network that is part of the seller's information technology hardware environment 135. For example, the seller's e-commerce site 115, internal auction application 120, local database 130, and business information management system(s) 140 may be located on servers or other computers that are part of a communication network-such as a local area network (LAN) or wide area network (WAN)-controlled by the seller. In an alternative embodiment, the seller's information technology hardware environment 135 may include a communication network that is shared by the seller with other network users. For example, the seller's e-commerce site 115, internal auction application 120, local database 130, and business information management system(s) 140 may be located on servers or other computers that are part of at least one internal seller communication network (e.g., a LAN and/or WAN) as well as a shared (i.e., shared by seller with other non-seller related entities) communication network such as the Internet. In either embodiment regardless of the network used for communication between the elements of the integrated auction system 100, seller communication 154 and buyer communication 155 with the integrated auction system 100 may occur over an external network (i.e., a network external to the seller and not under the seller's direct control), such as for example, the Internet. In an alternative embodiment, seller and buyer communication 154, 155 with the integrated auction application 100 may occur over a seller-controlled network (such as a seller-controlled wide area sales network) and/or may involve a combination of at least one seller-controlled network and at least one external network.

The integrated auction system 100 integrates a seller's business information management systems(s) 140, which serves as a backend system(s), with a seller's e-commerce site 115, serving as a front-end system, using an internal auction application 120 in order to provide auction services to the seller 110 and the buyer 105 according to one embodiment of the present invention. A seller business information management system 140 is a an application with at least one associated database 141 typically using a database management system (DBMS) that provides data storage and associated programming support for that data (e.g., a query system such as an SQL editor, optimization routines, program interfaces). For example, a seller may have an inventory control system 140 with its own inventory database. The business information management system(s) 140 may contain product information and availability information used in generating an auction and performing order generation to fulfill a winning bidder's order according to one embodiment of the present invention. The seller's e-commerce site 110 allows a buyer 105 to participate in an auction over a communication network. For example, a seller Web site on the Internet offering goods and/or services (electronic commerce) is one example of a seller e-commerce site 115. An auction in the integrated auction system 100 is made available to the buyer 105 through the seller e-commerce site 115 which may serve as the buyer portal to the integrated auction system 100 according to one embodiment of the present invention. The seller 110 creates and manages auctions through the internal auction application 120 which integrates 153 information from the business information management system(s) 140 and provides the interaction processing 151 with the buyer 105 through the seller e-commerce site 115.

FIG. 1b is a diagram illustrating a general integrated auction process according to one embodiment of the present invention. FIG. 1b is similar to FIG. 1a but adds arrows to indicate the steps in this general integrated auction process. The illustration simplifies the process and is shown to further illustrate how the elements of the integrated auction system interact according to this embodiment. When a seller 110 creates an auction using the seller-side application 121 of the internal auction application 120, the internal auction application 120 integrates 161 information from the seller's business information management system(s) 140 in order to facilitate the auction creation process and to leverage the already existing asset(s) of the seller. In addition, the seller business information management system(s) 140 may be used to identify and/or determine a target group to associate with an auction in order to create a bidder restriction on the auction. The seller's business information management system(s) 140 may include CRM components or may be CRM-based facilitating the target group identification process with the inherent CRM tools available. This first step 161 is the integration of the business information management system(s) 140 information to facilitate the generating of the auction according to this embodiment of the present invention.

The second step may have three distinct components 166-168 according to this embodiment of the present invention. The first part 166 of the second step is to save the created auction in the local database 130 of the internal auction application 120. The auction may be saved for later editing by the seller 110 if the auction is not published or activated (i.e., made available to the buyers). The publication and/or activation of the auction is the second part 167 of the second step according to this embodiment. Publication may be considered making the auction available to a customer 105 at a particular start time specified during the auction creation process. Activation may be considered immediately making the auction available to a buyer 105 regardless of a specified start time-the immediate publication of the auction. Both terms are used interchangeably throughout this document and should not be considered a particular distinction unless specifically noted. The publication and/or activation 167 of the auction makes the auction available to the buyer 105 through the seller's e-commerce site 115 if the customer 105 is authorized access to the auction by being included in the target group (i.e., bidder restriction) for the auction.

The third step may be viewed as having two components 171-172 according to this embodiment. The customer 105, if allowed in the bidder restriction, bids 171 on the available auctions through the seller e-commerce site 115 in the first component 171 of the third step. The bids and bidding information are sent 172 from the seller e-commerce site 115 to the internal auction application 120 in the second component 172 of the third step. At the conclusion of the bidding for the auction which may be manually concluded by the seller or automatically concluded according to a guideline such as for example a specified end date and time or upon reaching a price threshold, the internal auction application 120 in a fourth step 176 may determine the winner automatically or through seller 110 intervention and sends notification 176 to the winning bidder 105 while updating the auction information in database 130 and on the seller e-commerce site 115. The winning buyer 105 may then perform any necessary checkout procedures 181 in the first part of the fifth step 181 in this embodiment. The checkout may be performed through the seller e-commerce site 115 and provides the internal auction application 120 any necessary information for completing the order for the goods and/or services. The second part 182 of the fifth step is the internal auction application 120 sending the necessary information for the generation or completion of the order to the appropriate seller business information management system(s) 140 so that the order for the auction winner 105 may be completed and processed by the seller. FIG. 1b shows a simplification of the interaction between the components of the integrated auction system 100 according to one embodiment of the present invention.

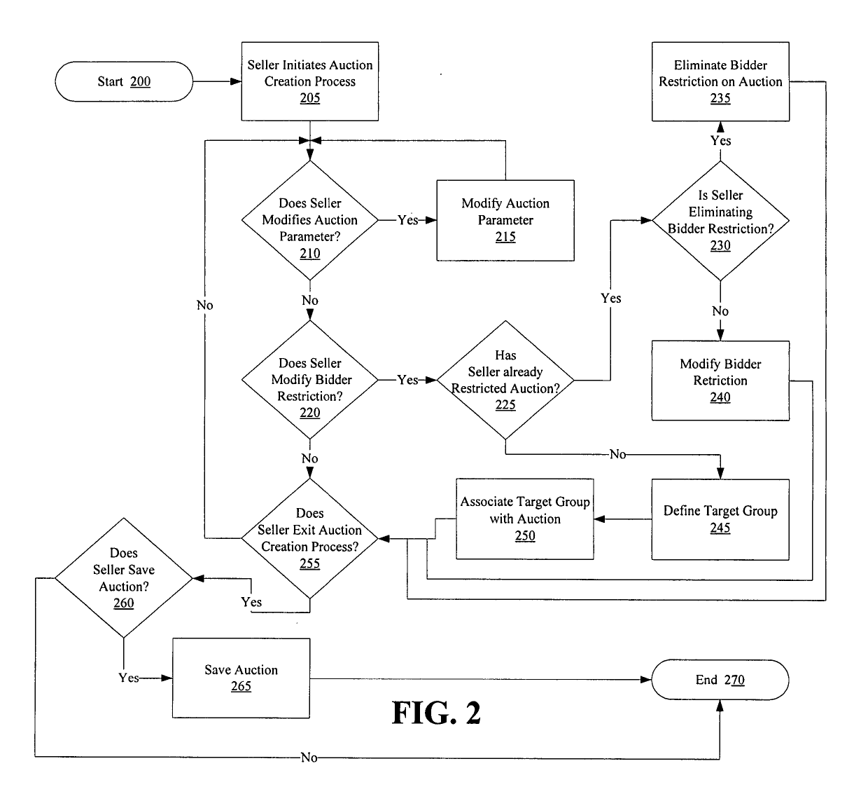

FIG. 2 is a flowchart illustrating the auction creation process using an internal auction application where the designation of a target group may be made according to one embodiment of the present invention. The process begins 200 when a seller 110 using the seller-side application 121 of the internal auction application 120 selects an option 205 (e.g., from a pull-down menu, button, copying an existing or previously created auction, etc.) to create an auction. This seller initiation of the auction creation process 205 not only allows a seller 110 to define auction parameters, it may also allow the seller 110 to include a restriction on accessing the auction according to this embodiment. An auction may be created from a “blank slate” where all auction parameters need to be specified by the seller 110 or an auction may be created using default values for the auction parameters. For example, if a new auction is created by copying another already created auction the auction parameters for the new auction may contain as default values the auction parameter values from the copied auction. In another example, a seller 110 may establish an auction profile in the seller-side application 121 of the internal auction application 120 according to one embodiment of the present invention. This auction profile may include default values (e.g., auction rules) that may be used for a newly created auction. Whether an auction is created using default values or whether auction parameters are empty and await seller specification, the seller 110 may decide to update auction parameters 210 during the auction creation process. If the seller attempts to modify an auction parameter 210, any rules regarding valid values for those auction parameters may be used to verify the values before the auction parameter is modified 215. The modification of auction parameters 215 may be an iterative process that can occur many times throughout the auction creation process.

In addition to modifying auction parameters 210, a seller 110 may also choose to modify any bidder restrictions 220 the seller has placed on the auction. If the seller chooses to modify a bidder restriction on an auction 220, a determination may be made whether a bidder restriction on the auction already exists 225. If a bidder restriction doe not already exist on the auction 225, a seller 110 may define a target group for the auction 245. A target group may consist of one or more customers 105 that the seller wants to provide access to the auction according to this embodiment of the present invention. A target group may be defined by linking a customer relationship management (CRM) system as one of or part of a seller's business information management system 140 with the internal auction application 120 seller-side application 121 in order to allow the seller 110 to define customer parameters to search for and/or select the one or more customers to include into the target group. In this manner the target group may be chosen using a combination of either one or more searches in a seller's CRM business information management system in a CRM component of a seller's business information management system, and/or with the manual selection of customers according to this embodiment.

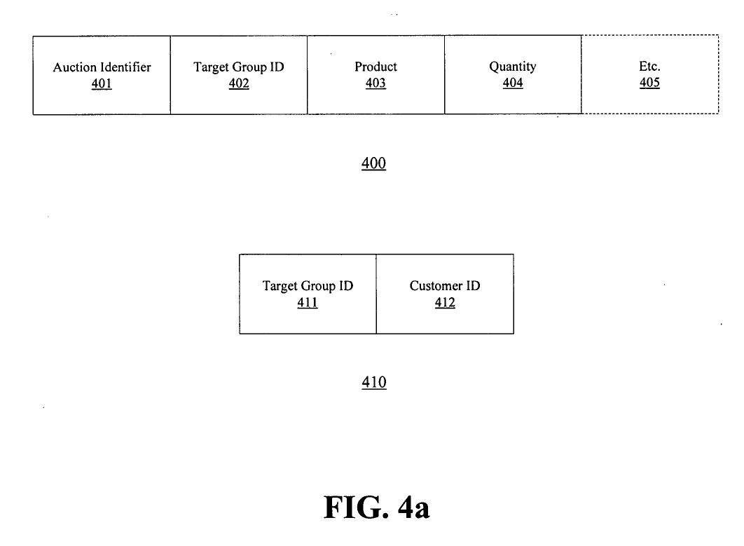

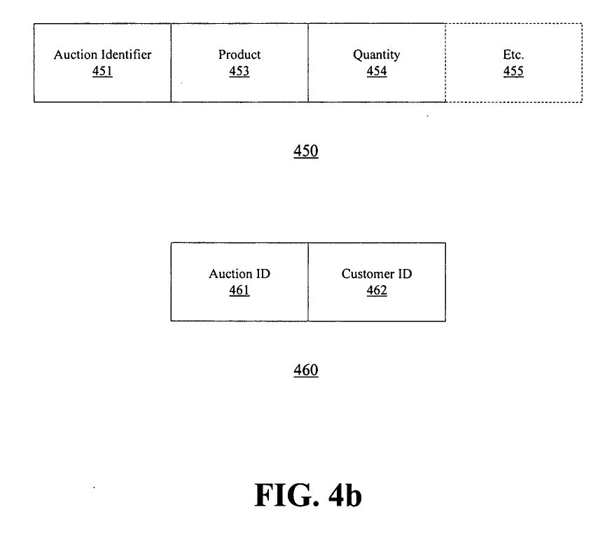

Once a target group is defined 245, the target needs to be associated with the auction 250 according to this embodiment of the present invention. In an example embodiment, the target group is defined 245 using the seller-side application 121 of the internal auction application 120 to access a CRM component in a seller's business information management system 140 or a CRM-based seller's business information management system 140 and, as a result, when the seller 110 saves the target group in the seller-side application 121 the association of the target group with the auction 250 is automatically made. In other words according to this embodiment, the target group is saved in a database 130, 141 in a manner where it is associated with the auction shown, for example, in FIGS. 4 & 5 discussed later herein. After the seller 110 defines the target group 245 and associates the target group with the auction 250, a seller 110 may decide to exit from or continue with the auction creation process 255.

If a seller 110 decides to modify a bidder restriction 220 and a bidder restriction already exists for the auction 225, the type of modification 230 the seller 110 is attempting to make determines the resulting action according to this embodiment. If the seller 110 is not attempting to eliminate the bidder restriction 230, the seller 110 may modify the bidder restriction 240 by adding and/or removing customers 105 from the target group. If the seller 110 is attempting to remove the existing bidder restriction 230, the bidder restriction may be eliminated 235 by the appropriate means. For example in an embodiment where the data for the auction includes a target group identifier (discussed later in association with FIG. 4a) and where one particular target group identifier is used to indicate no restrictions on the auction (i.e., open to everyone), eliminating the bidder restriction on the auction 235 may be implemented by at least in part changing the target group identifier to this no restriction target group identifier value. The information for the target group itself associating seller's customers with the target group (e.g., lookup table entries for the target group) may or may not be deleted in various embodiments depending upon whether there is any utility in saving the defined target group for later use. In another example where there is no target group identifier and the target group consists of customers 105 directly associated with the auction (discussed later in association with FIG. 4b), eliminating the bidder restriction on the auction 235 may be implemented by at least in part deleting the auction-to-customer association creating the restriction. Where a lookup table is used (discussed in FIG. 4b below), the records/tuples/rows associating the auction with a customer 105 may be deleted according to this embodiment. Depending upon how a bidder restriction is implemented in the internal auction application 120 and/or the seller's business information management system(s) 140 and/or their associated databases 130, 141, eliminating the bidder restriction 235 needs to be consistent with this implementation. After the seller 110 either modifies the bidder restriction 240 or eliminates the bidder restriction 235, a seller 110 may decide to exit from or continue with the auction creation process 255.

A seller 110 may decide to exit from the auction creation process 255 at any point by making the appropriate selection from the seller-side application 121 of the internal auction application 120 according to one embodiment of the present invention. As long as the seller 110 does not exit from the auction creation process, he/she may be able to make additional modifications to the auction parameters 215, define a target group 245 and associate it with the auction 250, eliminate a bidder restriction on the auction 235, and modify an existing bidder restriction 240 according to this embodiment. If the seller 110 exits from the auction creation process 255, he/she may save the defined auction information 260 as part of exiting 255 or he/she may abandon the created auction information. If the seller 110 decides to save the created auction information 260, the auction information may be saved 265 in the internal auction application database 130 and/or in a seller's business information management system(s) 140 database 141 before the auction creation process concludes 270 according to this embodiment. If the seller 110 abandons the created auction information 260, the auction information and the auction creation process according to this embodiment concludes 270 without the auction information being saved.

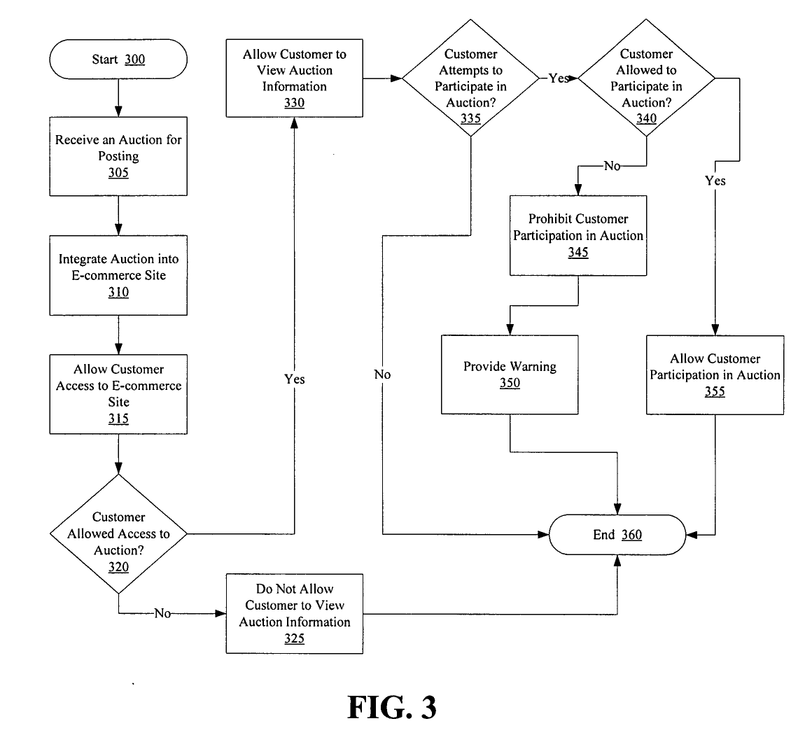

FIG. 3 is a flowchart illustrating the process for making available an auction with a defined target group on a seller's e-commerce site according to one embodiment of the present invention. The process begins 300 when an auction is received 305 by a seller e-commerce site 115 from a seller's internal auction application 120 as part of the internal auction system 100 according to this embodiment of the present invention. The receiving step 305 may include the auction (created using the internal auction application 120) becoming available to the seller e-commerce site 115 so that the auction may be displayed to a customer 105, who may be able to participate in the auction, in addition to the receiving step 305 including the potential actual receipt of the auction information in a message or object sent to the seller's e-commerce site 115. In this embodiment, the receiving step 305 represents the possible availability of the auction to a customer 105 through the seller e-commerce site 115 rather than just the receipt of an auction object or other auction information. The receiving step 305 may be initiated by the publication or activation of the auction. The publication of an auction may occur when a designated start date and time for the auction is reached resulting in the auction becoming available through the seller e-commerce site 115. The activation of an auction may also occur when a seller 110 designates that the auction become immediately available through the seller e-commerce site 115 regardless of what any designated start date and time may be (if one exists).

Once an auction is received 305 (i.e., available), the auction may be integrated 310 into the seller e-commerce site 115 by including the auction in the display of data on the site 115. Unlike the receiving step 305 where an auction becomes available to the seller e-commerce site 115 so that it may be displayed, the integration step 310 actually includes adding the now available auction into the data displayed in the seller e-commerce site 115 according to this embodiment. This integration 310 may occur, in one embodiment, by including the auction in a listing of auctions available for display to customers 105 on the seller e-commerce site 115. In another embodiment, the integration step 310 may occur by storing the auction information in a database local to or otherwise linked and/or accessed by the seller e-commerce site 115.

A customer 105 may be allowed to access the seller e-commerce site 315 by some means of customer identification according to this embodiment. For example, a customer 105 may have a username and password they enter to access the seller e-commerce site 115. Entering the username and password may associate the customer 105 with a customer identifier similar to the customer identifier used in designating the target group for an auction having a bidder restriction. A determination 320 may be made when a customer 105 accesses the seller e-commerce site 115 or when the customer 105 attempts to view or participate in auctions whether or not the customer 105 is allowed access 320 to a particular auction. If the customer 105 is not allowed access to an auction 320, the auction information is not displayed 325 to the customer on the seller e-commerce site 115. The customer 105 will not be allowed to view information 325 regarding auctions with a bidder restriction where the customer 105 is not included in the target group (i.e., within the bidder restriction) for the auction. The customer 105 may not even know the auction exists. If the customer 105 is included in the target group for an auction 320 and is therefore allowed accessed to the auction, the auction information may be displayed 330 to the customer 105 on the seller e-commerce site 115.

A customer 105 viewing an auction 330 may decide to participate in the auction 335. If the customer 105 is allowed to view an auction 330 and attempts to participate in the auction 335, a determination may be made 340 regarding whether the customer 105 is allowed to participate in the auction 340 in addition to viewing the auction 330. If the customer 105 is allowed to participate in the auction 340, the customer 105 may participate in the auction 355 and this process is concluded for that customer 105. For example, the customer 105 may enter a bid for the auction 355. If the customer 105 is not allowed to participate in the auction 340, the customer 105 may be prohibited from participating in the auction 345. For example if the customer 105 tries to click on an auction link in one of the seller e-commerce site 115 screens, the link may be inactive with no resulting access to the auction details. In another example if the customer 105 tries to enter a bid for the auction, there may be no active “enter bid” button and/or other implementation means (e.g., pull-down menu option, etc.) or the bid may not be registered for the auction. In addition, a warning message may be provided 350 to the customer 105 informing the customer 105 that they are not permitted to participate in the auction but are allowed only to view the auction. After this warning 350 and any prevented participation 345 by the customer 105, this process may conclude 360 for this customer 105. If a customer 105 viewing an auction 330 decides not to participate in the auction 335, this process may also conclude 360 for this customer 105.

In one embodiment of the present invention, a customer 105 that is allowed access to an auction may both view and participate in the auction. Therefore, the determination first made regarding whether a customer 105 is allowed to access an auction 320 also determines whether the customer 105 may participate in the auction 340 and as a result the steps 340, 345, and 350 are no longer needed according to this embodiment. Allowing the customer 105 to participate in the auction 355 occurs whenever the customer 105 decides to participate in an auction 335 he/she is allowed to access 320. In an alternative embodiment shown in FIG. 3, two different bidder restrictions may be implemented to first allow customers 105 to be able to view auctions and second to allow customers 105 to participate in auctions.

FIG. 4a is an example data architecture for implementing a bidder restriction for an auction using a target group according to one embodiment of the present invention. The data row 400 is a simplified example (which is not normalized) of the data fields that may exist for an auction according to one embodiment of the present invention. This data row 400 may be stored in at least one of the seller's business information management system(s) 140 databases 141 and/or the internal auction application 120 database 130 and the data row 400 may provide the basic information associated with the auction. In the example shown in FIG. 4a, the data row 400 contains an auction identifier field 401 containing a unique auction identifier, a target group identifier field 402 containing a unique target group identifier, a product field 403, a quantity field 404, and it may contain other potential fields indicated by the “Etc.” field 405. In addition to this data row 400, an auction may also use lookup tables and/or include data rows in other tables in order to indicate additional auction information. For example, a target group data row 410 may exist in a target group lookup table that associates a target group identifier 411 with a customer identifier 412 uniquely identifying a customer 105 on the seller's e-commerce site 115. This target group lookup table allows the target group to be defined with its constituent customers 105 by including a single row for each customer 105 associated with the target group. During the selection of the target group using the seller-side application 121 of the internal auction application 120, the seller 110 may use a CRM component in or CRM-based business information management system(s) 140 to provide customer 105 selection tools. Once the auction is saved, each selected customer 105 may be associated with the target group using a target group data row 410 in a target group lookup table (not shown). In addition, the target group may be saved in the data row 400 containing the main auction information. In addition to the target group lookup table, any value that may have multiple associations with the auction may be represented in a separate lookup table using known data normalization techniques. For example, multiple products 403 may be part of an auction so a separate lookup table associating an auction with a product may be used linking the main auction information in the data row 400 with the product information in the seller's business information management system 140 database 141. The term record, row, and tuple are used interchangeable herein to refer a record/row/tuple of data, the terms table and file are used interchangeably herein to refer to a table/file of a database, and the terms field and cell are used interchangeably herein to refer to a field/cell in row. These terms are not intended to imply a particular database structure (e.g., a hierarchical database or a relational database) for an embodiment of the present invention. Embodiments of the present may work effectively using any known database type and the present invention is not limited to a particular database structure.

FIG. 4b is an example data architecture for implementing a bidder restriction for an auction using a customer identifier instead of a target group according to one embodiment of the present invention. The data row 450 containing the main auction information does not include a target group identifier field 402 as shown in FIG. 4a. The example data row 450 contains an auction identifier field 451 containing a unique auction identifier, a product field 453, a quantity field 454, and it may contain other potential fields indicated by the “Etc.” field 455. Instead of using a target group identifier 402, the embodiment shown in FIG. 4b directly associates the auction identifier 461 with a customer identifier 462, uniquely identifying a customer 105 on the seller's e-commerce site 115, in a lookup table (not shown). This auction-customer lookup table identifies the customers 105 allowed to access the auction in one more auction identifier 461 to customer identifier 462 associations in an auction-customer row 460 of this lookup table. The seller 110 may still use a CRM component or CRM-based business information management system(s) 140 to provide customer 105 selection tools. Once the auction is saved, each selected customer 105 may be associated with the auction using a separate auction-customer row 460 of the lookup table (not shown). The principle difference between the embodiments for the data structures as shown in FIGS. 4a and 4b is that when a target group is defined, it may be used for multiple auctions. For example, a target group “X” comprising customers “A”, “B”, and “C” may be used for multiple auctions. This may be advantageous where certain target groups will likely be used for several auctions. In this case, the seller 110 may select an already defined target group during auction creation or editing to quickly provide a bidder restriction. In the embodiment shown in FIG. 4b where no target group identifier is used, the seller 110 must define the target group for each auction having a bidder restriction even if the target group is the same for multiple auctions.

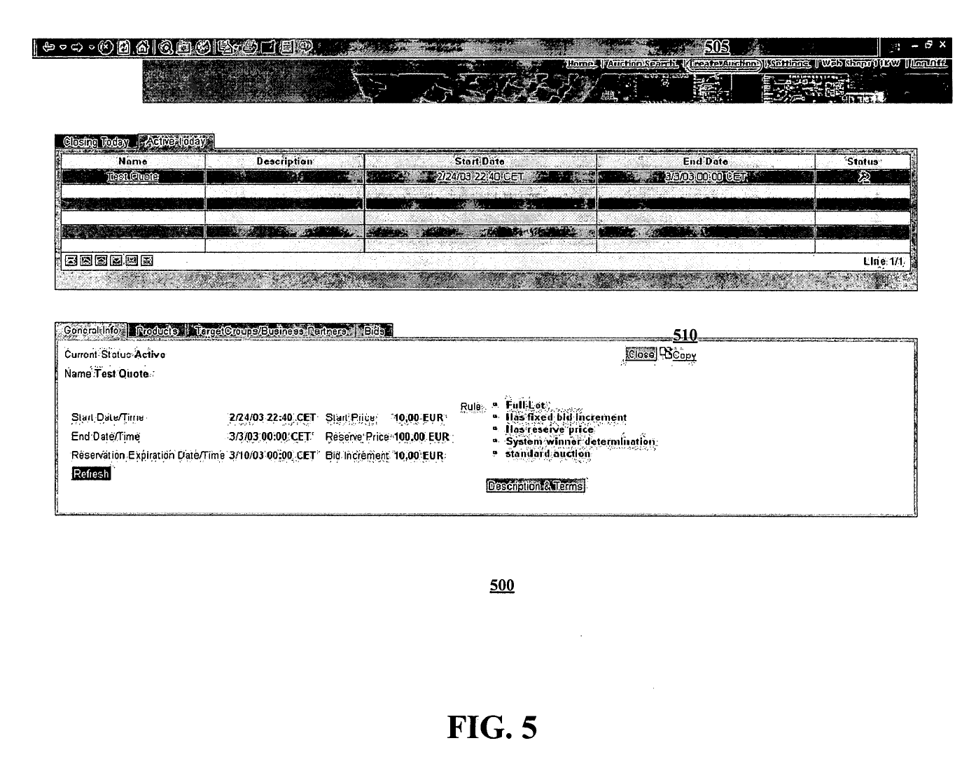

FIG. 5 is a screen shot from an internal auction application illustrating an auction listing screen from which a seller may choose to create a new auction with a bidder restriction according to one embodiment of the present invention. According to this embodiment, the internal auction application 120 may link a seller's existing business information management system(s) 140 with a seller's e-commerce site 115 in order to provide internal auction services. The internal auction application 120 may be a component-based multi-tier application developed according to the Java® 2 platform, enterprise edition standard (J2EE®) and running on top of a web application. This embodiment is only one example of the platforms and software that may be used for the internal auction application 120.

A seller 110 may use the seller-side application 121 of the internal auction application 120 to create or generate an auction. This may be accomplished by selecting a create option link 505 on an appropriate screen 500 of the internal auction application 120, such as the auction listing screen 500 shown, or through the use of menu items (not shown), buttons (not shown), or other known means (not shown). An auction may also be created by selecting an existing auction and then selecting (e.g., clicking on) a “Copy” link 510, button (not shown), menu option (not shown), or other selection means (not shown). Once the seller 110 initiates the create auction process, an auction creation screen may be displayed.

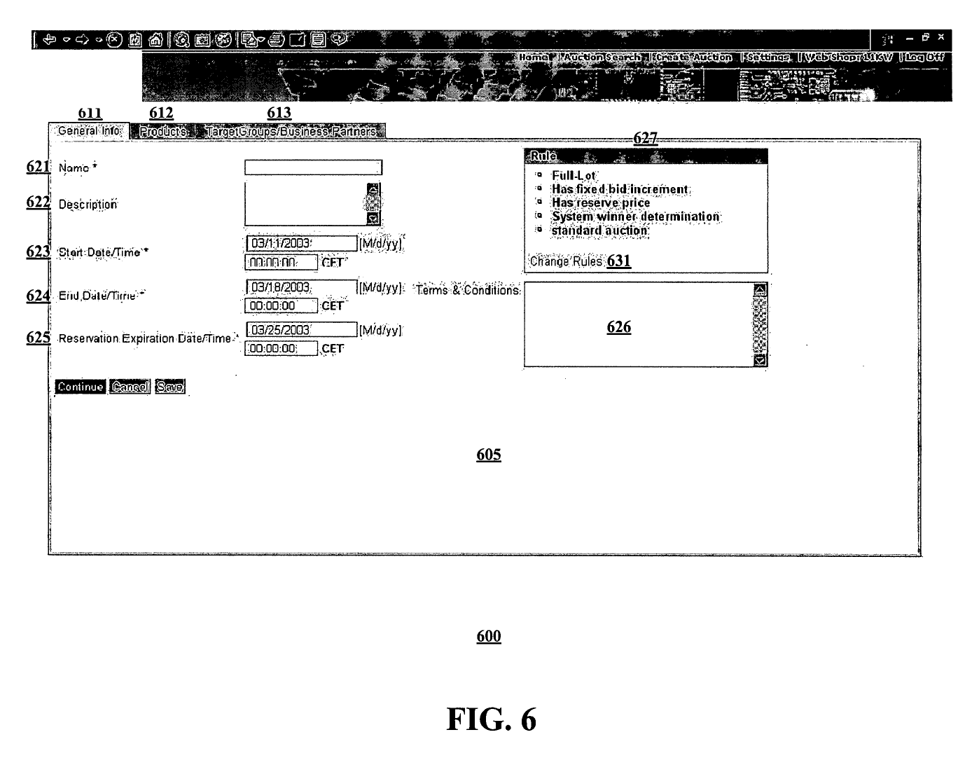

FIG. 6 is a screen shot from an internal auction application illustrating an auction creation screen from which a bidder restriction may be specified according to one embodiment of the present invention. The auction creation screen 600 includes an auction creation table 605 containing three tabs 611-613 for the auction information. The first tab 611 is the “General Info” tab and contains the general auction information that a seller 110 may specify according to this embodiment. An auction name 621, auction description 622, start date and time 623, end date and time 624, reservation expiration date and time 625, terms and condition 626, and auction rules 627 may be specified in this “General Info” tab 611. If the auction is created by copying an already created auction, these fields 621-627 may initially be populated with data from the copied auction. If the auction is not being created from a copied auction, these fields 621-627 may contain default values and/or may be empty. For example, the auction rules 627 may be a default setting for the seller 110. If the seller 110 wants to change thee rules, he/she 110 may select the “Change Rules” link 631 or other provided option to make the appropriate changes.

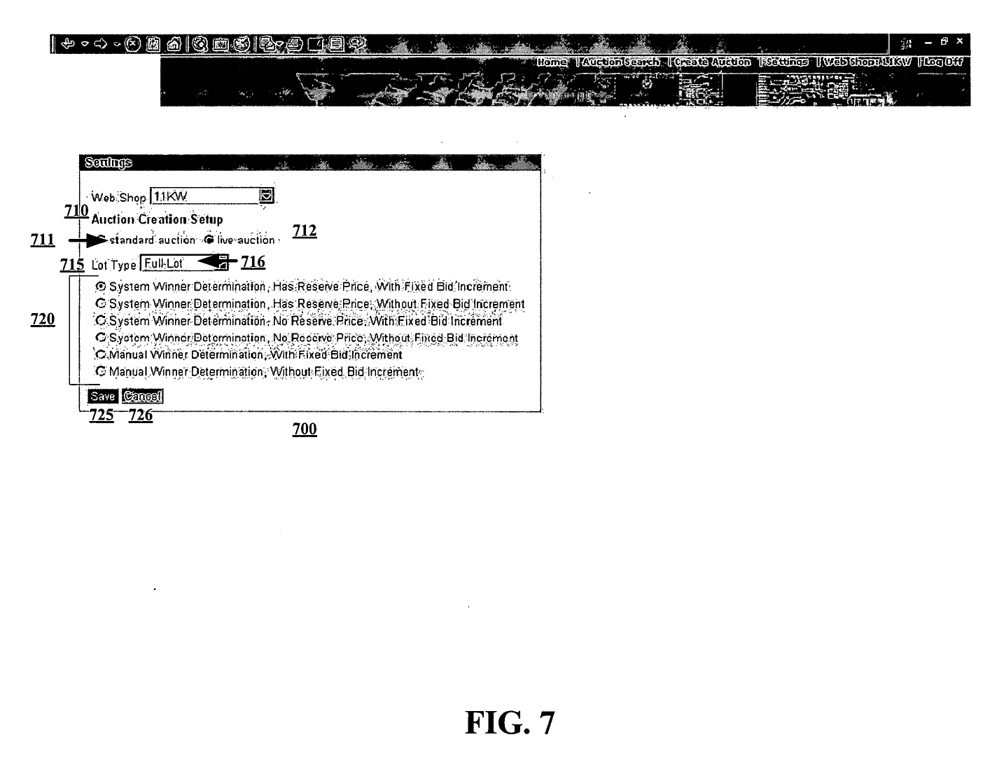

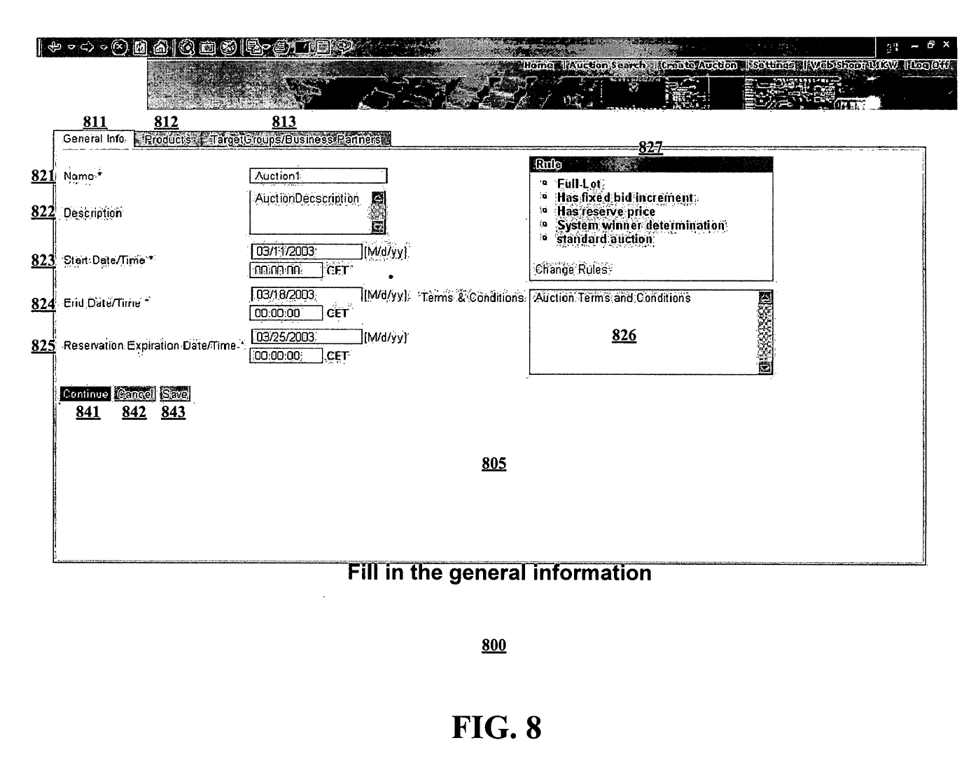

FIG. 7 is a screen shot from an internal auction application illustrating the change rules screen presented to a seller during the auction creation process according to one embodiment of the present invention. When a seller 110 initiates the “Change Rules” option, the change rules screen 700 may be displayed with the selected rules shown. For example, an auction type 710 may be selected such as a standard auction 711 and a live auction 712. A lot type 715 may also be selected such as the full lot type 716 shown. A full lot may indicate that the entire contents of the auction are sold together to a winning bidder rather than a broken lot auction where the highest bidder may bid on and win a portion of the auction up to the specified auction quantity with the next highest bidder winning part or all of the remaining portion of the lot, etc. Other system rules 720 are indicated in a radio field of rule combinations which a seller 110 may select. The rules shown in the radio field 720 may be broken down into more detailed selection options (not shown) and other rules may also be included (not shown). The seller's changes to these auction rules may be saved 725 or they may be canceled 726 with the internal auction application 120 returning to the auction creation screen 600 and the auction creation table 605. FIG. 8 is a screen shot from an internal auction application illustrating the auction creation screen with general auction information entered according to one embodiment of the present invention. Auction information in the “General Info” tab 811 of the auction creation table 805 has been entered in this embodiment in the auction name field 821, auction description field 822, start date and time fields 823 (default data), end date and time fields 824 (default data), reservation expiration date and time fields 825 (default data), terms and condition field 826, and auction rules table 827. At any time during the auction creation process, the seller 110 may cancel 842 the auction creation process without saving the auction information already entered by selecting the Cancel button 842 or by other appropriate means (not shown). The seller 110 may also save 843 the auction data by selecting the Save button 843 or by other appropriate means (not shown). The seller 110 may continue entering information for the auction by selecting (clicking on) the Continue button 841 or by selecting another tab 812, 813 of the auction creation table 805.

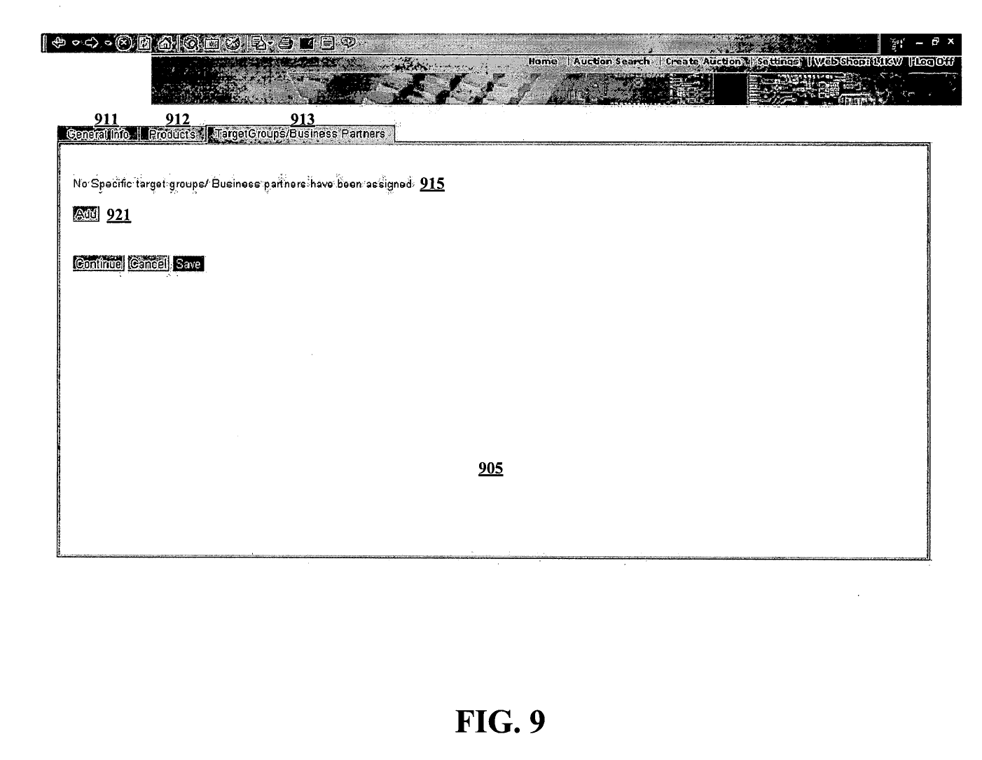

FIG. 9 is a screen shot from an internal auction application illustrating the initiation of a bidder restriction on the auction by designating target groups according to one embodiment of the present invention. In addition to entering general auction information in the “General Info” tab 911 of the auction creation table 905 and product information for the auction in the “Products” tab 912, the seller 110 may also designate target groups for the auction thereby creating a bidder restriction on the auction by using the “Target Groups/Business Partners” tab 913 of the auction creation table 905. When the seller 110 selects the “Target Groups” tab 913, existing target groups may be displayed (not shown) or if no target groups are defined for the auction a message stating so 915 may be displayed in this embodiment. The term “target group” refers to one or more customers 105 that may be designated using search and/or selection parameters for example as part of a CRM component in or CRM-based seller business information management system 140. The term “business partner” refers to an individual customer 105 that is designated by the seller 110 with or without the use of search and/or selection parameters. The term “target group” is used herein interchangeably to refer to both even though the may be differentiated in how the seller 110 selects each. The seller 110 may add a target group by selecting (e.g., clicking on) the “Add” button 921.

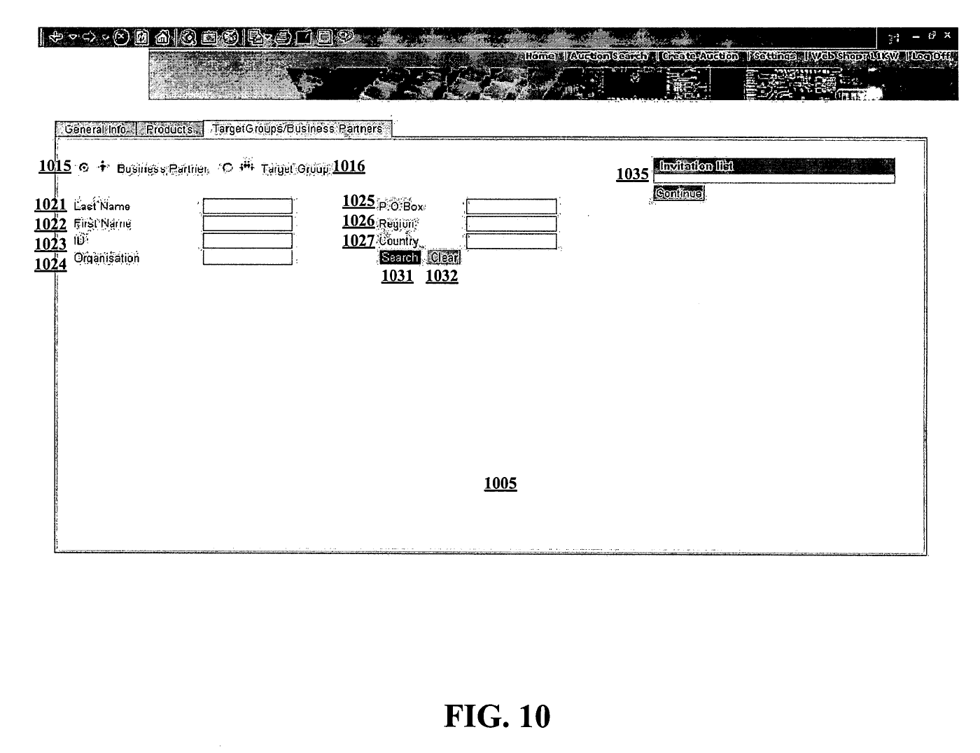

FIG. 10 is a screen shot from an internal auction application illustrating the target group designation screen of the auction creation process where a bidder restriction may be created according to one embodiment of the present invention. The auction creation table 1005 allows the seller 110 to select either a single business partner 1015 (i.e., a single customer) at one time or to select a target group 1016 at one time (i.e., one or more customers at one time) through the displayed radio field in this embodiment. The selection fields 1021-1027 shown in the auction creation table 1005 relate to the selection of a single business partner 1015 as indicated. The seller 110 may enter values including wild card values in one or more of the displayed fields 1021-1027-the last name field 1021, the first name field 1022, the customer identifier field 1023, the organization field 1024, the P.O. Box field 1025, the region field 1026, and the country field 1027-and conduct a search by selecting the search button 1031 to retrieve matching business partners (customers) to choose from. The seller 110 may also clear the values in these fields 1021-1027 by selecting (e.g., clicking on) the clear button 1032. An invitation list 1035 is also shown (empty) which is a listing of the selected business partners and target groups associated with the auction. When the seller 110 conducts a search for a business partner, a search results screen is displayed.

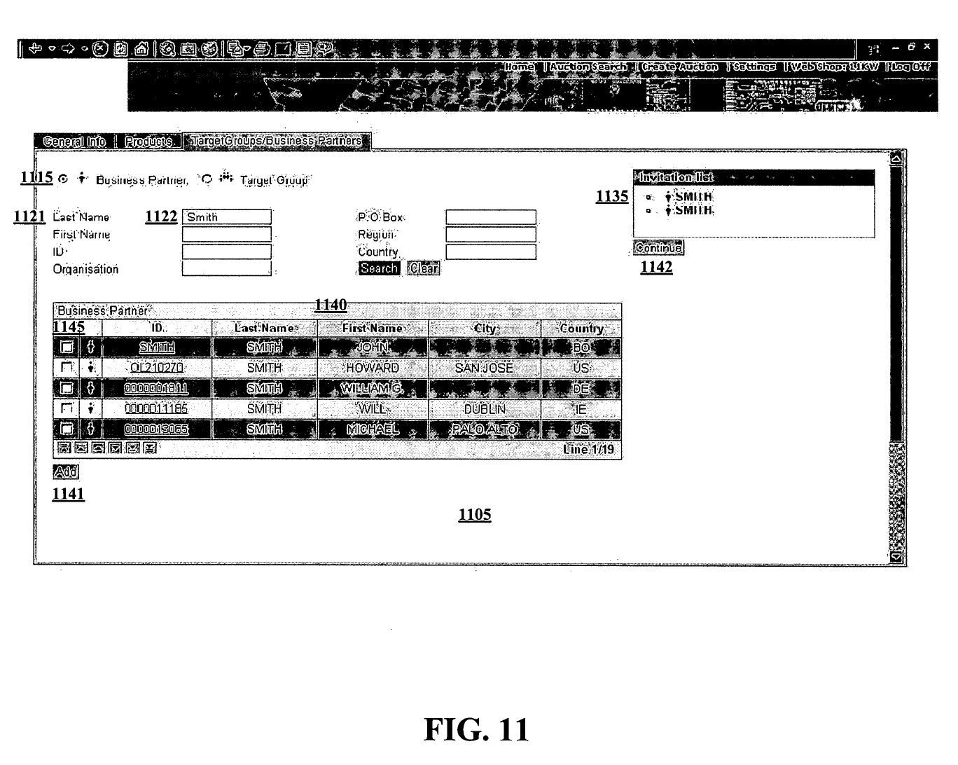

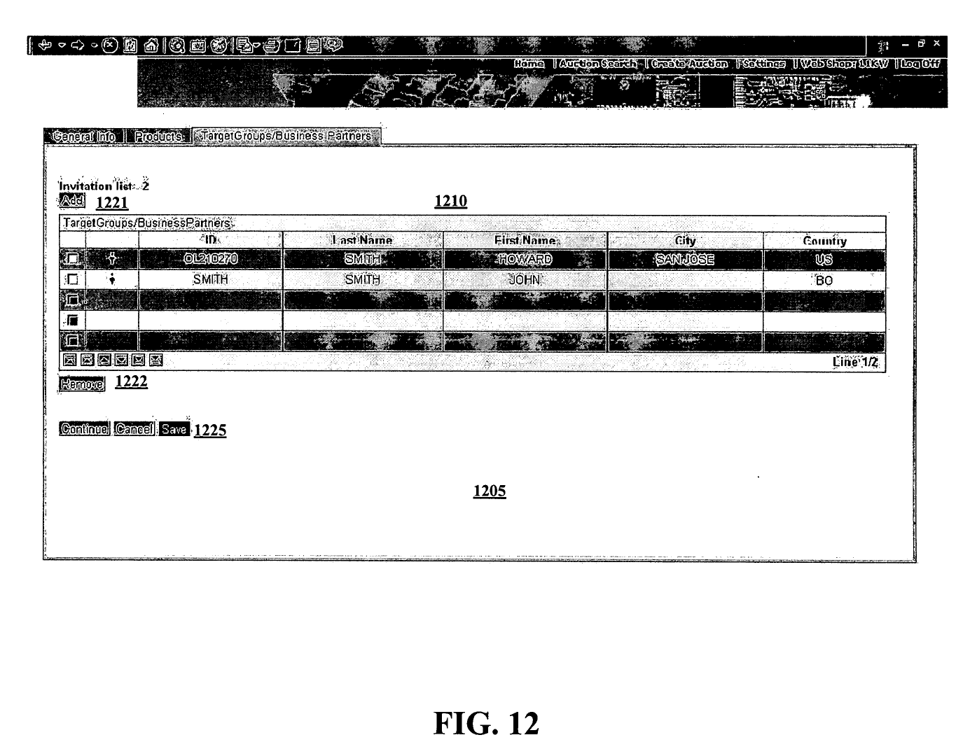

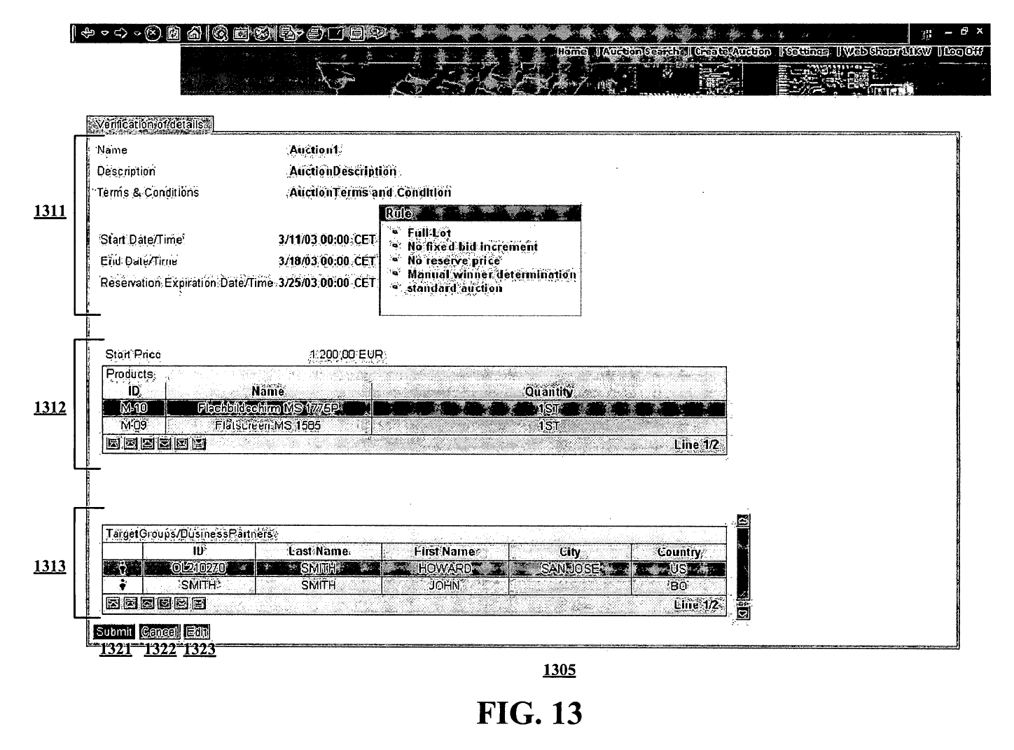

FIG. 11 is a screen shot from an internal auction application illustrating a business partner search results screen for selecting bidder restrictions on an auction during the auction creation process according to one embodiment of the present invention. A business partner 1115 search is selected with a search conducted for any customer 105 having a last name 1121 of “Smith” 1122. The search results 1140 are displayed in a search results table 1140 in the search results screen 1105. The seller 110 may select one or more customers 105 from the search results 1140 (by for example clicking on the associated radio field 1145 box) and may add 1141 them to the invitation list 1135 (i.e., the target group or bidder restriction list for the auction) by selecting the add button 1141. The selected customers (i.e., business partners) are displayed in the invitation list 1135 which may be edited by selecting the associated Continue 1142 button. FIG. 12 is a screen shot from an internal auction application illustrating an invitation list containing the selected customers in the bidder restriction or target group for the auction according to one embodiment of the present invention. The detailed view of the invitation list 1210 contains a listing of the selected (i.e., invited) business partners and target groups that make up the bidder restriction on the auction. The seller may add 1221 to the selected target group in this screen 1205 and may also remove 1222 from the selected customers 105 in the listing 1210. As previously stated, the seller 110 may save the auction information by selecting the save button 1225. FIG. 13 is a screen shot from an internal auction application illustrating a verification screen for the saved auction information from the auction creation process according to one embodiment of the present invention. The verification screen 1305 contains the general auction information 1311, the product information 1312, and the target groups 1313 identified by the seller 110 during the auction creation process. The seller 110 may continue to edit the information by selecting the edit button 1323, cancel the auction creation process deleting the entered information by selecting the cancel button 1322, and the seller may save the auction information by selecting the submit button 1321 according to this embodiment.

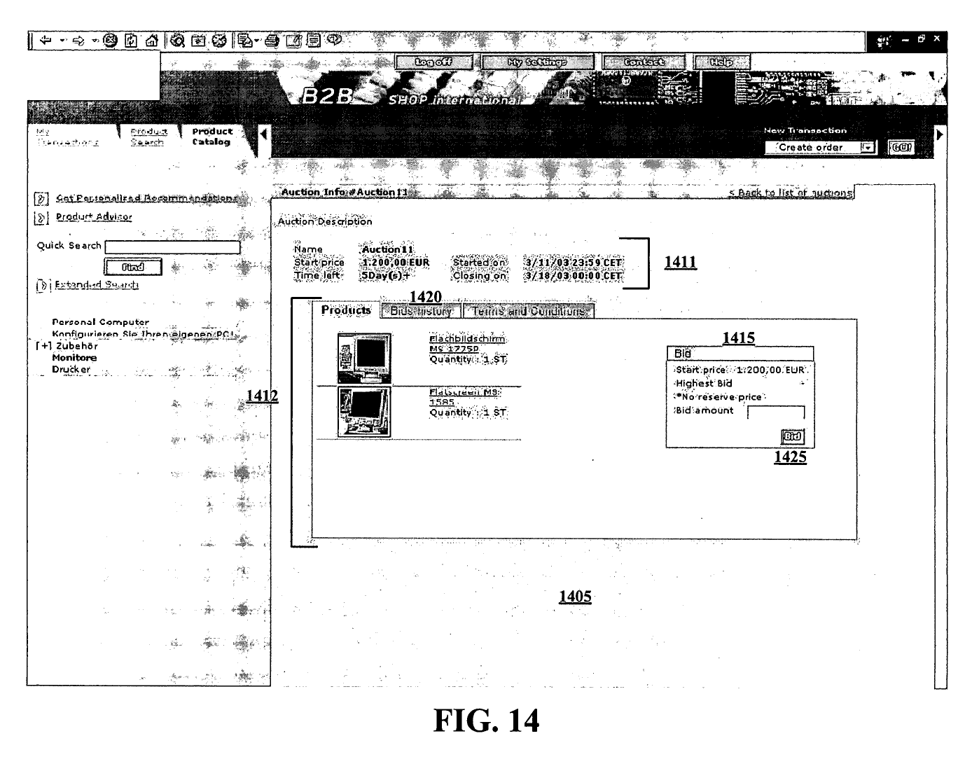

FIG. 14 is a screen shot from a seller's e-commerce site illustrating auction information that a customer may view if they are part of a target group for a bidder restriction on the auction according to one embodiment of the present invention. A customer 105 authorized to participate in a bidder restricted auction may view the auction information through the seller e-commerce site 115. General auction information 1411 and product information 1412 are shown on the auction information screen 1405 of the seller e-commerce site 115 according to this embodiment. In one embodiment of the present invention, an authorized customer 105 that is part of the target group for the bidder restricted auction may be allowed to both view the auction information and participate in the auction. The customer 105 may participate in the auction by placing bids in the bid box 1415 and selecting the bid button 1425 and reviewing the bid history in the “Bids-history” tab 1420 on the screen 1405. In an alternative embodiment, a customer is separately authorized to view auction information and to participate in the auction so a customer 105 may only see auction information 1411, 1412 and not be presented with a bid box 1415 allowing the customer 105 to participate. A customer who is not authorized to view or participate in an auction will not be allowed to see any auction information according to this embodiment so will not be able to find the auction.

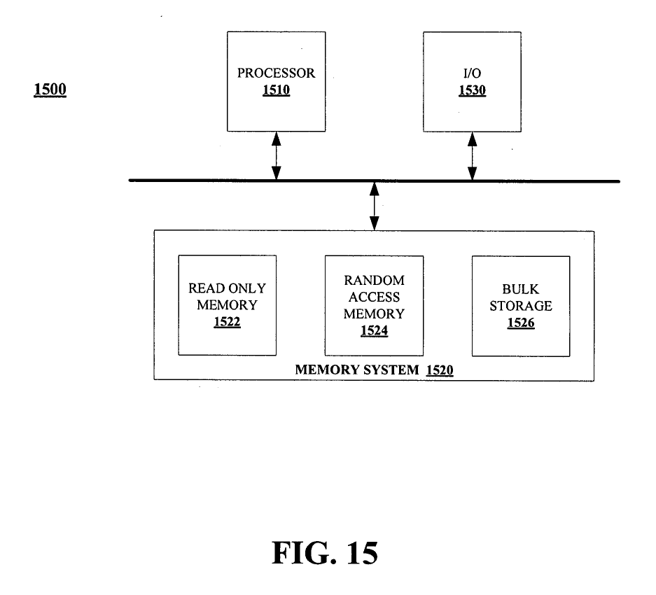

FIG. 15 is a block diagram illustrating the platform on which the method and system for controlling a customer's access to an auction for a product in an internal auction system using an internal auction application may operate according to one embodiment of the present invention. Functionality of the foregoing embodiments may be provided on various computer platforms executing program instructions. One such platform 1500 is illustrated in the simplified block diagram of FIG. 15. There, the platform 1500 is shown as being populated by a processor 1510, a memory system 1520 and an input/output (I/O) unit 1530. The processor 1510 may be any of a plurality of conventional processing systems, including microprocessors, digital signal processors and field programmable logic arrays. In some applications, it may be advantageous to provide multiple processors (not shown) in the platform 1500. The processor(s) 1510 execute program instructions stored in the memory system. The memory system 1520 may include any combination of conventional memory circuits, including electrical, magnetic or optical memory systems. As shown in FIG. 15, the memory system may include read only memories 1522, random access memories 1524 and bulk storage 1526. The memory system not only stores the program instructions representing the various methods described herein but also can store the data items on which these methods operate. The I/O unit 1530 would permit communication with external devices (not shown).

What is claimed is:

1. A method for controlling a customer's access to an auction for a product in an internal auction system using an internal auction application, comprising:
creating by the internal auction application the auction for the product as a function of at least one communication with a seller's business information management system;
identifying a target group using a customer relationship management functionality;
associating the target group with the auction for the product;
publishing the auction for the product on a seller's e-commerce site; and
restricting the customer's access to the auction for the product as a function of the identified target group, wherein the restricted access is at least one of a restriction on viewing the auction and a restriction on participating in the auction.

2. The method according to claim 1, further comprising:
sending, by the internal auction application, a customer parameter to the seller's business information management system, wherein the seller's business information management system includes the customer relationship management functionality.

3. The method according to claim 2, the identifying step further comprising:
identifying a target group using a customer relationship management functionality, wherein the identified target group is received from the seller's business information management system as a function of the sent customer parameter.

4. The method according to claim 1, wherein the target group includes at least one customer.

5. The method according to claim 1, the restricting step further comprising:
restricting the customer's access to the auction for the product on the seller's e-commerce site as a function of the identified target group, wherein the restricted access is at least one of a restriction on viewing the auction through the seller's e-commerce site and a restriction on participating in the auction on the seller's e-commerce site.

6. A method for controlling a customer's access to an auction for a product in an internal auction system using an internal auction application, comprising:
receiving by the seller's business information management system a customer parameter from the internal auction application, wherein the seller's business information management system includes a customer relationship management functionality;
identifying by the seller's business information management system a target group as a function of the received customer parameter, wherein the target group is identified to control the customer's access to the auction;
returning the target group to the internal auction application; and
processing an order for the product in the auction as a function of the target group.

7. The method according to claim 6, wherein the target group includes at least one customer.

8. A system for controlling a customer's access to an auction for a product in an internal auction system using an internal auction application, comprising:
a memory system;
an input/output unit; and
a processor, wherein the processor is adapted to:
(i) create by the internal auction application the auction for the product as a function of at least one communication with a seller's business information management system;
(ii) identify a target group using a customer relationship management application;
(iii) associate the target group with the auction for the product;
(iv) publish the auction for the product on a seller's e-commerce site; and
(v) restrict the customer's access to the auction for the product as a function of the identified target group, wherein the restricted access is at least one of a restriction on viewing the auction and a restriction on participating in the auction.

9. A system for controlling a customer's access to an auction for a product in an internal auction system using an internal auction application, comprising:
a memory system;
an input/output unit; and
a processor, wherein the processor is adapted to:
(i) receive by the seller's business information management system a customer parameter from the internal auction application, wherein the seller's business information management system includes a customer relationship management functionality;
(ii) identify by the seller's business information management system a target group as a function of the received customer parameter, wherein the target group is identified to control the customer's access to the auction;
(iii) return the target group to the internal auction application; and
(iv) process an order for the product in the auction as a function of the target group.

10. A computer readable medium including instructions adapted to execute a method for controlling a customer's access to an auction for a product in an internal auction system using an internal auction application, the method comprising:
creating by the internal auction application the auction for the product as a function of at least one communication with a seller's business information management system;
identifying a target group using a customer relationship management application;
associating the target group with the auction for the product;
publishing the auction for the product on a seller's e-commerce site; and
restricting the customer's access to the auction for the product as a function of the identified target group, wherein the restricted access is at least one of a restriction on viewing the auction and a restriction on participating in the auction.

11. A computer readable medium including instructions adapted to execute a method for controlling a customer's access to an auction for a product in an internal auction system using an internal auction application, the method comprising:
receiving by the seller's business information management system a customer parameter from the internal auction application, wherein the seller's business information management system includes a customer relationship management functionality;
identifying by the seller's business information management system a target group as a function of the received customer parameter, wherein the target group is identified to control the customer's access to the auction;
returning the target group to the internal auction application; and
processing an order for the product in the auction as a function of the target group.
